(19) United States
(12) Patent Application Publication
(10) Pub. No.: US 2025/0206066 A1
(43) Pub. Date: Jun. 26, 2025

(54) TIRE

(71) Applicant: The Yokohama Rubber Co., LTD., Kanagawa (JP)

(72) Inventors: Atsushi TANNO, Kanagawa (JP); Daichi WATABE, Kanagawa (JP)

(21) Appl. No.: 18/850,361

(22) PCT Filed: Mar. 27, 2023
(86) PCT No.: PCT/JP2023/012302

§ 371 Date: Sep. 24, 2024

(30) Foreign Application Priority Data
Mar. 29, 2022 (JP) 2022-054688

(51) Int. Cl. B60C 11/00; B60C 11/03; B60C 11/13

(52) U.S. Cl. CPC B60C 11/0058; B60C 11/0008; B60C 11/1353; B60C 2011/0025; B60C 2011/0033; B60C 2011/0353; B60C 2011/0355

(57) ABSTRACT

In a tire, a stress relaxation layer extends continuously from a groove bottom of a main groove to road contact surfaces of left and right land portions and covers edge portions of the land portions in a cross-sectional view in a tire meridian direction. A width Wc of the stress relaxation layer on the road contact surfaces of the land portions with respect to a groove depth Hg1 of the main groove is in the range of 0.06≤Wc/Hg. A total width ΣWc of the stress relaxation layer on the road contact surface of one of the land portions with respect to a ground contact width Wb1, Wb2 of the land portions is in the range of ΣWc/Wb≤0.70.

### TECHNICAL FIELD

The technology relates to a tire and particularly relates to a tire that can provide the durability performance of a stress relaxation layer and the wet performance of a tire in a compatible manner.

### BACKGROUND ART

Recent tires employ a configuration in which a stress relaxation layer is provided at a groove bottom of a main groove in order to reduce groove cracking that occurs mainly at the groove bottom of the main groove. The technologies described in Japan Unexamined Patent Publication Nos. H02-045202 and 2005-523193 are known tires employing such a configuration.

### SUMMARY

The technology provides a tire that can provide the durability performance of a stress relaxation layer and the wet performance of a tire in a compatible manner.

A tire according to an embodiment of the technology includes: a tread rubber exposed on a tread surface; main grooves and land portions formed in the tread surface; and a stress relaxation layer formed on a surface of a groove bottom of a main groove of the main grooves. The stress relaxation layer is composed mainly of a diene rubber material and a non-diene rubber material and contains carbon, a vulcanizing agent, and a vulcanization accelerator. The stress relaxation layer extends continuously from the groove bottom of the main groove to a road contact surface of at least one land portion of the land portions and covers an edge portion of the land portion in a cross-sectional view in a tire meridian direction. A width Wc of the stress relaxation layer on the road contact surface of the land portions with respect to a groove depth Hg of the main groove is in a range of 0.06≤Wc/Hg, and a total width ΣWc of the stress relaxation layer on the road contact surface of one of the land portions with respect to a ground contact width Wb of the land portions is in a range of ΣWc/Wb≤0.70.

In the tire according to an embodiment of the technology, since the stress relaxation layer extends continuously from the groove bottom of the main groove to the road contact surface of the land portion and covers the edge portion of the land portion, the adhesion area of the stress relaxation layer to the tread rubber is increased as compared with a configuration in which the stress relaxation layer is formed only at the groove bottom and groove walls. This suppresses the separation of the stress relaxation layer during rolling of the tire. The above-described lower limit of the ratio Wc/Hg appropriately ensures the width Wc of the stress relaxation layer on the road contact surface of the land portion and appropriately suppresses the separation of the stress relaxation layer. The above-described upper limit of the ratio ΣWc/Wb ensures the exposed area of the tread rubber on the road contact surface of the land portion and thus ensures the wet performance of the tire at the early stage of wear. These have an advantage that both the durability of the stress relaxation layer and the wet performance of the tire can be provided in a compatible manner.

### BRIEF DESCRIPTION OF DRAWINGS

FIG. 1 is a cross-sectional view in a tire meridian direction illustrating a tire according to an embodiment of the technology.

FIG. 2 is a plan view illustrating a tread surface of the tire illustrated in FIG. 1.

FIG. 3 is an enlarged view illustrating a half region of the tread surface of the tire illustrated in FIG. 2.

FIG. 4 is a cross-sectional view illustrating a shoulder main groove illustrated in FIG. 3.

FIG. 5 is a cross-sectional view illustrating the shoulder main groove illustrated in FIG. 3.

FIG. 6 is a cross-sectional view illustrating the shoulder main groove illustrated in FIG. 3.

FIG. 7 is a cross-sectional view illustrating the shoulder main groove illustrated in FIG. 3.

FIG. 8 is an explanatory diagram illustrating a modified example of the tire illustrated in FIG. 2.

FIG. 9 is a cross-sectional view illustrating a center main groove illustrated in FIG. 8.

FIG. 10 is an explanatory diagram illustrating a modified example of a stress relaxation layer illustrated in FIG. 4.

FIG. 11 is an explanatory diagram illustrating a modified example of the tire illustrated in FIG. 2.

FIG. 12 is an explanatory diagram illustrating a narrow shallow groove of a shoulder land portion illustrated in FIG. 11.

FIG. 13 is an explanatory diagram illustrating the narrow shallow groove of the shoulder land portion illustrated in FIG. 11.

FIG. 14 is an explanatory diagram illustrating a modified example of the stress relaxation layer illustrated in FIG. 4.

FIG. 15 is a table showing the results of performance tests of tires according to embodiments of the technology.

FIG. 16 is a table showing the results of performance tests of tires according to embodiments of the technology.

FIG. 17 is an explanatory diagram illustrating a test tire of Comparative Example.

### DETAILED DESCRIPTION

Embodiments of the technology will be described in detail below with reference to the drawings. Note that the technology is not limited to the embodiments. Constituents of the embodiments include constituents that are substitutable and are obviously substitutes while maintaining consistency with the embodiments of the technology. A plurality of modified examples described in the embodiments can be combined in a discretionary manner within the scope apparent to one skilled in the art.

### Tire

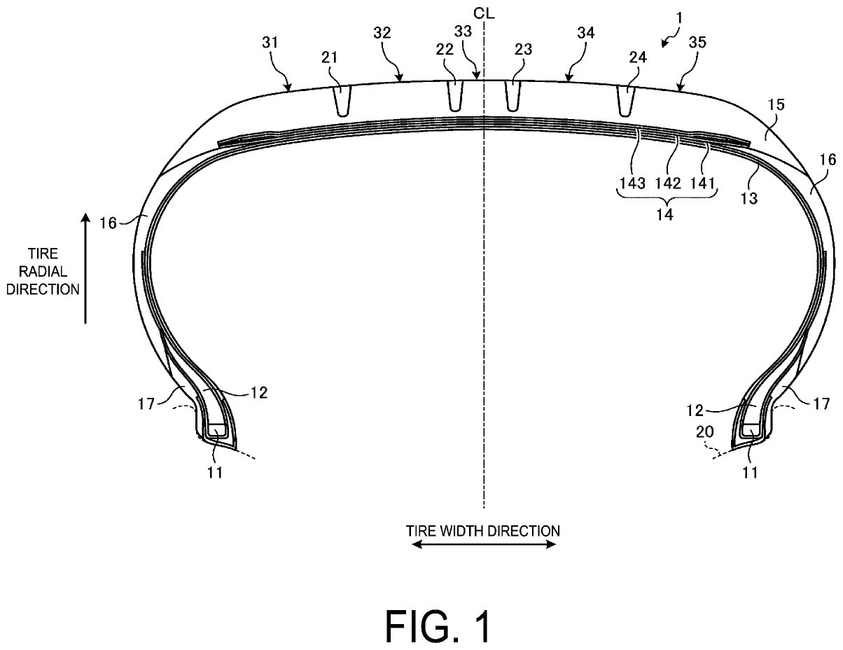

FIG. 1 is a cross-sectional view in a tire meridian direction illustrating a tire 1 according to an embodiment of the technology. The same drawing illustrates a cross-sectional view of a half region in a tire radial direction. In this embodiment, a pneumatic radial tire for use on passenger cars will be described as an example of the tire.

In the same drawing, a cross-section in the tire meridian direction is defined as a cross-section of the tire taken along a plane that includes a tire rotation axis (not illustrated). A tire equatorial plane CL is defined as a plane that passes through a midpoint of a tire cross-sectional width specified by the Japan Automobile Tyre Manufacturers Association Inc. (JATMA) and that is perpendicular to the tire rotation axis. A tire width direction is defined as a direction parallel to the tire rotation axis, and the tire radial direction is defined as a direction perpendicular to the tire rotation axis.

The tire 1 has an annular structure centered on the tire rotation axis, and includes a pair of bead cores 11, 11, a pair of bead fillers 12, 12, a carcass layer 13, a belt layer 14, a tread rubber 15, a pair of sidewall rubbers 16, 16, and a pair of rim cushion rubbers 17, 17 (see FIG. 1).

The pair of bead cores 11, 11 respectively include one or a plurality of bead wires made of steel and wound in an annular shape a plurality of times, are embedded in bead portions, and constitute cores of the left and right bead portions. The pair of bead fillers 12, 12 are respectively disposed on an outer circumference of the pair of bead cores 11, 11 in the tire radial direction and reinforce the bead portions.

The carcass layer 13 has a single layer structure including one carcass ply or a multilayer structure including a plurality of carcass plies layered, extends in a toroidal shape between the left and right bead cores 11, 11, and constitutes the backbone of the tire. Both end portions of the carcass layer 13 are turned back toward outer sides in the tire width direction and fixed to wrap the bead cores 11 and the bead fillers 12. The carcass ply of the carcass layer 13 is made by covering a plurality of carcass cords made of steel or an organic fiber material (for example, aramid, nylon, polyester, or rayon) with a coating rubber and performing a rolling process on the carcass cords, and has a cord angle (defined as an inclination angle of the carcass cords in a longitudinal direction with respect to a tire circumferential direction) of 80 degrees or more and 100 degrees or less.

The belt layer 14 is formed by layering a plurality of belt plies 141 to 143 and disposed around the outer circumference of the carcass layer 13. The belt plies 141 to 143 include a pair of cross belts 141, 142 and a belt cover 143.

The pair of cross belts 141, 142 are made by covering a plurality of belt cords made of steel or an organic fiber material with a coating rubber and performing a rolling process on the belt cords, and have a cord angle (defined as an inclination angle of the belt cords in a longitudinal direction with respect to the tire circumferential direction) of 15 degrees or more and 55 degrees or less as an absolute value. The pair of cross belts 141, 142 have cord angles having mutually opposite reference signs and are layered by making the belt cords intersect with each other in the longitudinal direction of the belt cords (a so-called crossply structure). The pair of cross belts 141, 142 are disposed in a layered manner on an outer side of the carcass layer 13 in the tire radial direction.

The belt cover 143 is made by covering belt cover cords made of steel or an organic fiber material with a coating rubber and has a cord angle of 0 degrees or more and 10 degrees or less as an absolute value. The belt cover 143 is, for example, a strip material formed by covering one or a plurality of belt cover cords with a coating rubber, and the strip material is wound on the outer circumferential surfaces of the cross belts 141, 142 a plurality of times in a spiral-like manner in the tire circumferential direction. The belt cover 143 is disposed to cover the entirety of the cross belts 141, 142.

The tread rubber 15 is disposed on an outer circumference of the carcass layer 13 and the belt layer 14 in the tire radial direction and constitutes a tread portion of the tire 1. The tread rubber 15 includes a cap tread and an undertread (not illustrated). The cap tread is made of a rubber material that is excellent in ground contact characteristics and weather resistance and is exposed over the entire tire outer circumferential surface to constitute a tread surface. Specifically, silica is blended in the cap tread in order to reduce the rolling resistance of the tire and to improve the wet performance of the tire. Further, in the cap tread in which silica is blended, carbon black having a particle size of nm or more and 150 nm or less is preferably blended in the cap tread in order to increase the adhesion to a stress relaxation layer 4 to be described below. The undertread is made of a rubber material that is excellent in heat resistance and is disposed by being sandwiched between the cap tread and the belt layer 14 (see FIG. 1) to constitute a base portion of the tread rubber 15.

The pair of sidewall rubbers 16, 16 are respectively disposed on an outer side of the carcass layer 13 in the tire width direction to constitute left and right sidewall portions. The pair of rim cushion rubbers 17, 17 extend from an inner side in the tire radial direction of the left and right bead cores 11, 11 and turned back portions of the carcass layer 13 toward the outer side in the tire width direction, to constitute rim fitting surfaces of the bead portions.

### Tread Surface

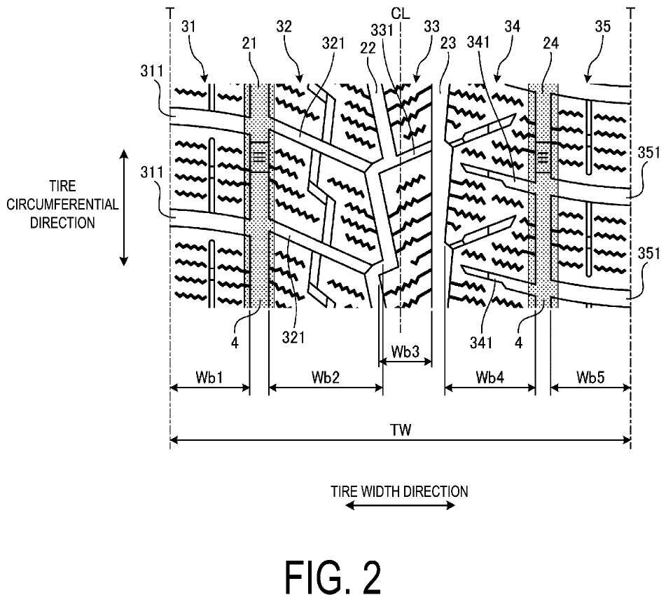

FIG. 2 is a plan view illustrating the tread surface of the tire 1 illustrated in FIG. 1. The same drawing illustrates a tread surface of a winter tire. In the same drawing, “tire circumferential direction” refers to a direction about the tire rotation axis. The reference sign T denotes a tire ground contact edge, and a dimension symbol TW denotes a tire ground contact width.

As illustrated in FIG. 2, the tire 1 includes, at the tread surface, four circumferential main grooves 21 to 24 and five rows of land portions 31 to 35.

The circumferential main grooves 21 to 24 include a pair of shoulder main grooves 21, 24 and two center main grooves 22, 23. The circumferential main grooves 21 to 24 have an annular structure extending continuously along the entire circumference of the tire. The shoulder main grooves 21, 24 are circumferential main grooves located on the outermost side in the tire width direction and are defined in respective left and right regions between which the tire equatorial plane CL lies as a boundary. The center main grooves 22, 23 are defined as circumferential main grooves closer to the tire equatorial plane CL side than the shoulder main grooves 21, 24.

“Main groove” is defined as a groove for which indication of a wear indicator specified by JATMA is mandatory. The circumferential main grooves 21 to 24 have a groove width of 4.0 mm or more and a groove depth of 6.2 mm or more.

The groove width is measured as a maximum value of a distance between opposed groove walls of a groove opening portion on the tread contact surface when the tire is mounted on a specified rim, inflated to a specified internal pressure, and in an unloaded state. In a configuration in which the groove opening portion includes a notch portion or a chamfered portion, the groove width is measured by using, as end points, intersection points of an extension line of the tread contact surface and extension lines of the groove walls, in a cross-sectional view parallel to a groove width direction and a groove depth direction.

The groove depth is measured as a maximum value of a distance from the tread contact surface to the groove bottom when the tire is mounted on a specified rim, inflated to a specified internal pressure, and in an unloaded state. In a configuration in which the groove bottom includes partial recess/protrusion portions or a sipe, the groove depth is measured excluding the partial recess/protrusion portions or the sipe.

“Specified rim” refers to a “standard rim” defined by JATMA, a “Design Rim” defined by the Tire and Rim Association, Inc. (TRA), or a “Measuring Rim” defined by the European Tyre and Rim Technical Organisation (ETRTO). “Specified internal pressure” refers to a “maximum air pressure” specified by JATMA, the maximum value in “TIRE LOAD LIMITS AT VARIOUS COLD INFLATION PRESSURES” specified by TRA, or “INFLATION PRESSURES” specified by ETRTO. A specified load refers to a “maximum load capacity” specified by JATMA, the maximum value in “TIRE LOAD LIMITS AT VARIOUS COLD INFLATION PRESSURES” specified by TRA, or “LOAD CAPACITY” specified by ETRTO. However, in JATMA, in the case of a tire for a passenger vehicle, the specified internal pressure is an air pressure of 180 kPa, and the specified load is 88% of the maximum load capacity at the specified internal pressure.

In the configuration of FIG. 2, a distance (dimension symbol omitted in the drawing) from the tire equatorial plane CL to a groove center line of each of the left and right shoulder main grooves 21, 24 is in the range of 19% or more and 34% or less of a tire ground contact width TW.

The groove center line is defined as an imaginary line connecting midpoints of a distance between groove walls opposed to each other.

The tire ground contact width TW is measured as a maximum linear distance in a tire axial direction on a contact surface between the tire and a flat plate when the tire is mounted on the specified rim, inflated to the specified internal pressure, placed perpendicular to the flat plate in a static state, and subjected to a load corresponding to the specified load.

A tire ground contact edge T is defined as the maximum width position in the tire axial direction on the contact surface between the tire and a flat plate when the tire is mounted on the specified rim, inflated to the specified internal pressure, placed perpendicular to the flat plate in a static state, and subjected to a load corresponding to the specified load.

The land portions 31 to 35 include a pair of shoulder land portions 31, 35, a pair of middle land portions 32, 34, and one row of center land portion 33. The land portions 31 to 35 are defined and formed by the circumferential main grooves 21 to 24 and form an annular road contact surface that extends along the entire circumference of the tire. The shoulder land portions 31, 35 are defined as land portions that are defined by the shoulder main grooves 21, 24 and located on the outer side in the tire width direction. The pair of shoulder land portions 31, 35 are disposed in the left and right regions between which the tire equatorial plane CL lies as a boundary. The middle land portions 32, 34 are defined as land portions that are defined by the shoulder main grooves 21, 24 and located on the inner side in the tire width direction. The pair of the middle land portions 32, 34 are disposed in the left and right regions between which the tire equatorial plane CL lies as a boundary. The center land portion 33 is defined as a land portion located closer to the tire equatorial plane CL side than the middle land portions 32, 34.

In FIG. 2, ground contact widths Wb1, Wb5 of the shoulder land portions 31, 35 with respect to the tire ground contact width TW are in the range of 12% or more and 26% or less. Ground contact widths Wb2, Wb4 of the middle land portions 32, 34 with respect to the tire ground contact width TW are in the range of 8% or more and 27% or less. A ground contact width Wb3 of the center land portion 33 with respect to the tire ground contact width TW is in the range of 10% or more and 23% or less.

The ground contact width of a land portion is measured as a maximum linear distance in the tire axial direction on a contact surface between the land portion and a flat plate when the tire is mounted on the specified rim, inflated to the specified internal pressure, placed perpendicular to the flat plate in a static state, and loaded with a load corresponding to the specified load.

In the configuration of FIG. 2, since the tire 1 includes the pair of shoulder main grooves 21, 24 and the two center main grooves 22, 23 as described above, the pair of shoulder land portions 31, 35, the pair of middle land portions 32, 34, and the single center land portion 33 are defined. However, no such limitation is intended, and the tire 1 may include one center main groove or three or more center main grooves (not illustrated). In the former configuration, the center land portion is omitted, and in the latter configuration, two or more rows of center land portions are defined.

In the configuration of FIG. 2, the center main groove 22 on one side (the left side in the drawing) has a zigzag shape formed by alternately connecting long portions and short portions in the tire circumferential direction. The left and right shoulder main grooves 21, 24 have a straight shape. However, no such limitation is intended, any of the circumferential main grooves 21 to 24 may have a straight shape, or may have a zigzag shape, a wave-like shape, or a step shape having an amplitude in the tire width direction (not illustrated). For example, a configuration in which all of the circumferential main grooves 21 to 24 have a straight shape (not illustrated) may be employed.

In the configuration of FIG. 2, the left and right shoulder land portions 31, 35, the middle land portion 32 on one side (the left side in the drawing), and the center land portion 33 each include through lug grooves 311, 321, 331, 351 passing through the land portions 31, 32, 33, 35, and thus these land portions 31, 32, 33, 35 are divided into block rows in the tire circumferential direction. The lug groove 311 of the middle land portion 34 on the other side includes one-side open lug grooves 341, and thus the land portion 34 forms a rib having a road contact surface that is continuous in the tire circumferential direction. Furthermore, each of the land portions 31 to 35 includes a plurality of sipes (reference signs omitted in the drawings).

The lug grooves 311 to 351 are lateral grooves extending in the tire width direction, have a groove width of 1.5 mm or more and a groove depth of 3.0 mm or more, and open to function as grooves when the tire comes into contact with the ground.

### Stress Relaxation Layer

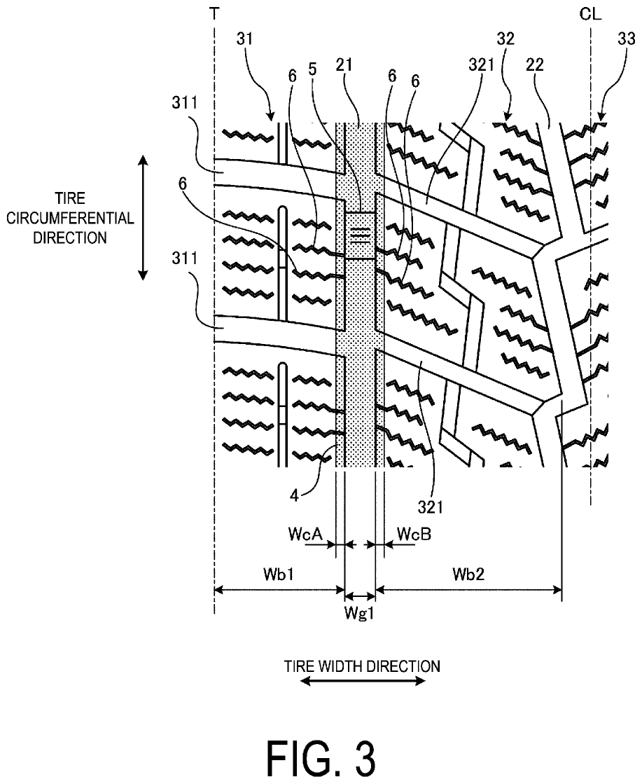

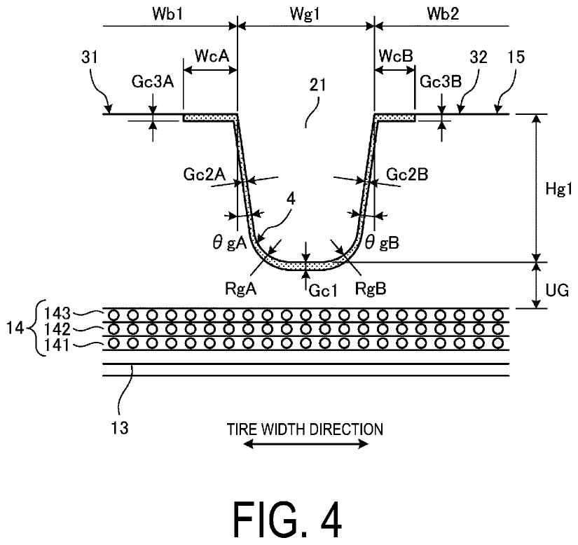

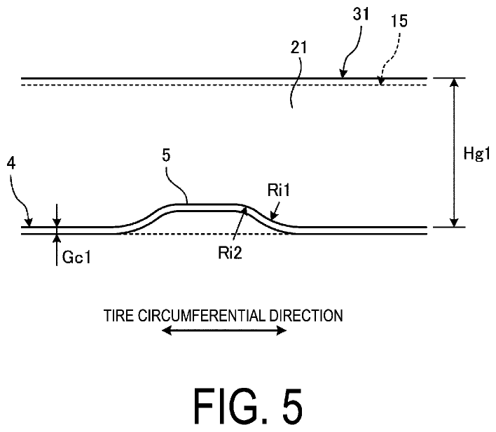

FIG. 3 is an enlarged view illustrating a half region of the tread surface of the tire 1 illustrated in FIG. 2. FIGS. 4 and 5 are cross-sectional views illustrating the shoulder main groove 21 illustrated in FIG. 3. In these drawings, FIG. 4 illustrates an enlarged cross-sectional view of the shoulder main groove 21 in the tire width direction, and FIG. 5 illustrates an enlarged cross-sectional view along the shoulder main groove 21 in the tire circumferential direction.

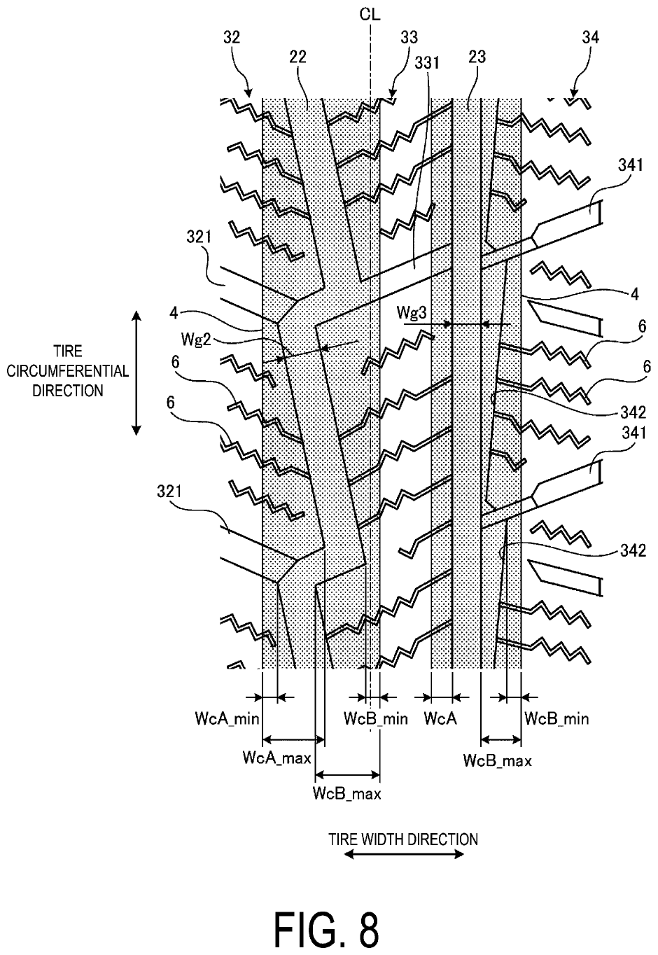

The tire 1 includes the stress relaxation layer 4 that is formed on each of the surfaces of the groove bottoms of the main grooves 21, 24 and suppresses groove cracking. In the configuration of FIG. 2, the stress relaxation layer 4 is formed in each of the left and right shoulder main grooves 21, 24 in which groove cracking is likely to occur. On the other hand, the stress relaxation layer 4 is not formed in the center main grooves 22, 23. However, no such limitation is intended, and the stress relaxation layer 4 may be formed at the center main grooves 22, 23 in addition to the shoulder main grooves 21, 24 (see FIG. 8 described below).

Here, the stress relaxation layer 4 formed in the shoulder main groove 21 on one side (left side in the drawing) will be described as an example, and the shoulder main groove 24 on the other side is the same as the shoulder main groove 21 on the one side, and thus the description thereof will be omitted.

The stress relaxation layer 4 is composed mainly of a diene rubber material and a non-diene rubber material and contains carbon, a vulcanizing agent, and a vulcanization accelerator. The diene rubber is selected from the group consisting of diene polymers including natural rubber and synthetic diene rubber (isoprene rubber (IR), butadiene rubber (BR), styrene-butadiene rubber (SBR), acrylonitrile-butadiene rubber (NBR), chloroprene rubber (CR), and the like). The non-diene rubber is selected from the group consisting of non-diene polymers including synthetic non-diene rubber (butyl rubber (IIR), ethylene propylene rubber (EPDM, EPM), urethane rubber, silicone rubber, and the like). The stress relaxation layer 4 preferably contains no resin component in order to ensure weather resistance.

The stress relaxation layer 4 preferably contains no anti-aging agent. Such a configuration is preferable in that the transfer of the stress relaxation layer 4 to a mold is suppressed and the coloring of the stress relaxation layer 4 is suppressed in a configuration in which a coating material of the stress relaxation layer 4 is applied to the unvulcanized tread rubber 15 and a vulcanization molding process is performed as described below.

However, no such limitation is intended, and the stress relaxation layer 4 may contain an anti-aging agent. In that case, it is preferable not to use an amine-based anti-aging agent but to blend another anti-aging agent (for example, a phenol-based, phosphorous-based, organic thioacid-based, or benzimidazole-based anti-aging agent) in an amount of 0.1 parts by weight or more and 5 parts by weight or less per 100 parts by weight of the rubber components.

A modulus Mc of the stress relaxation layer 4 at 100% elongation at 100° C. is in the range of 0.3 MPa≤Mc≤2.8 MPa, preferably 0.4 MPa≤Mc≤2.3 MPa, more preferably 0.5 MPa≤Mc≤1.8 MPa, and still more preferably 0.6 MPa≤Mc≤1.5 MPa. The above-described lower limit suppresses breakage of the stress relaxation layer 4 due to a foreign matter (for example, a pebble) entering the main groove during rolling of the tire, and the above-described upper limit suppresses uneven wear of the land portion due to excessive increase in the modulus Mc of the stress relaxation layer 4.

The modulus Mc of the stress relaxation layer 4 at 100% elongation at 100° C. with respect to a modulus Mt of the tread rubber 15 at 100% elongation at 100° C. is in the range of 0.45≤Mc/Mt≤1.15 and preferably in the range of 0.50≤Mc/Mt≤1.10. For example, the above-described ratio Mc/Mt is preferably in the range of 0.50≤Mc/Mt≤0.90 in a summer tire, and the above-described ratio Mc/Mt is preferably in the range of 0.70≤Mc/Mt≤1.10 in a winter tire.

The moduli Mc, Mt are measured by a tensile test at a temperature of 100° C. with a dumbbell-shaped test piece in accordance with JIS K6251 (using a number 3 dumbbell). The modulus Mt of the tread rubber 15 is measured as a modulus of a rubber material of a portion in surface contact with the stress relaxation layer 4.

A rubber hardness Hc of the stress relaxation layer 4 with respect to a rubber hardness Ht of the tread rubber 15 is in the range of 0≤Ht−Hc≤32 and preferably in the range of 2≤Ht−Hc≤27. The above-described lower limit ensures the rubber hardness Hc of the stress relaxation layer 4 and suppresses breakage of the stress relaxation layer 4 due to a foreign matter (for example, a pebble) entering the main groove during rolling of the tire. The above-described upper limit suppresses uneven wear of the land portion due to excessive increase in the rubber hardness Hc of the stress relaxation layer 4.

The rubber hardnesses Hc, Ht are measured under a temperature condition of 20° C. in accordance with JIS K6253. The rubber hardness Ht of the tread rubber 15 is measured as a rubber hardness of a rubber material in surface contact with the stress relaxation layer 4 out of the rubber materials constituting the tread rubber 15.

A tensile strength TBc of the stress relaxation layer 4 with respect to a tensile strength TBt of the tread rubber 15 is in the range of 0.30≤TBc/TBt≤0.90 and preferably in the range of 0.35≤TBc/TBt≤0.88. The above-described lower limit ensures the tensile strength TBc of the stress relaxation layer 4 and ensures the breaking durability of the stress relaxation layer 4 against a strain during rolling of the tire. The above-described upper limit suppresses the separation of the stress relaxation layer due to excessive increase in the tensile strength TBc of the stress relaxation layer 4. The tensile strength TBc of the stress relaxation layer 4 with respect to the tensile strength TBt of the tread rubber 15 is preferably in the range of 3 MPa≤TBt−TBc≤15 MPa.

The tensile strengths TBc, TBt are measured by a tensile test at room temperature (a temperature of 20° C.) with a dumbbell-shaped test piece in accordance with JIS K6251 (using a number 3 dumbbell). The tensile strength TBt of the tread rubber 15 is measured as a tensile strength of a rubber material of a portion in surface contact with the stress relaxation layer 4.

As illustrated in FIGS. 3 and 5, the stress relaxation layer 4 extends continuously along the main groove 21 in the tire circumferential direction. As illustrated in FIGS. 3 and 4, the stress relaxation layer 4 extends continuously not only on the groove bottom of the main groove 21 but also on the groove wall and the groove opening portion to cover the entire inner wall of the main groove 21. Further, as illustrated in FIG. 4, in a cross-sectional view in the tire meridian direction, the stress relaxation layer 4 bends at the edge portions of the land portions 31, 32 and extends to the road contact surfaces of the land portions 31, 32 to cover the edge portions of the land portions 31, 32. The stress relaxation layer 4 includes edge portions at the road contact surfaces, that is, the ground contact regions of the land portions 31, 32.

On the other hand, as illustrated in FIGS. 3 and 4, the road contact surfaces of the land portions 31, 32 each include, at the center portions of the land portions 31, 32 in the width direction, a non-covered region (reference sign omitted in drawings) not covered with the stress relaxation layer 4. In the non-covered regions, the tread rubber 15 is exposed to form the ground contact surfaces of the land portions 31, 32. In the configuration of FIG. 3, the shoulder main groove 21 has a straight shape, and the edge portions of the stress relaxation layer 4 have a straight shape along the shoulder main groove 21.

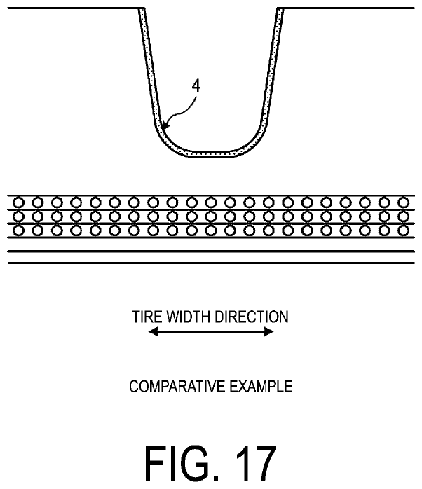

In the above-described configuration, since the stress relaxation layer 4 extends continuously from the groove bottom of the main groove 21 to the road contact surfaces of the land portions 31, 32 to cover the edge portions of the land portions 31, 32, the adhesion area of the stress relaxation layer 4 to the tread rubber 15 is increased as compared with a configuration in which the stress relaxation layer 4 is formed only at the groove bottom and the groove walls (see FIG. 17 described below). Accordingly, the separation of the stress relaxation layer 4 during rolling of the tire is suppressed. The exposed area of the tread rubber 15 on the tread contact surface is appropriately ensured by the upper limit of the width Wc of the stress relaxation layer 4 described below, appropriately ensuring the wet performance of the tire in the early stage of wear from the new condition of the tire until the stress relaxation layer 4 is worn out. Accordingly, as compared to the configuration in which the stress relaxation layer is provided only at the groove bottom and the groove walls (see FIG. 17 described below) and a configuration in which the stress relaxation layer covers the entire region of the road contact surface of the land portion (not illustrated), both the separation durability of the stress relaxation layer 4 and the wet performance of the tire are provided effectively in a compatible manner.

In FIGS. 3 and 4, the width Wc of the stress relaxation layer 4 on the road contact surfaces of the land portions 31, 32 (a width WcA in the shoulder land portion 31 and a width WcB in the middle land portion 32 in FIG. 3) with respect to a groove depth Hg (Hg1) of the main groove 21 is in the range of 0.06≤Wc/Hg and preferably in the range of 0.10≤Wc/Hg. The above-described lower limit appropriately ensures the width Wc of the stress relaxation layer 4 on the road contact surfaces of the land portion 31, 32 and appropriately suppresses the separation of the stress relaxation layer 4. That is, since the amount of deformation of the main groove 21 during rolling of the tire increases as the depth of the main groove 21 increases, the groove width Wc of the stress relaxation layer 4 is set to be larger as the groove depth Hg of the main groove 21 increases. The upper limit of the ratio Wc/Hg is not particularly limited but is subject to restrictions by other conditions.

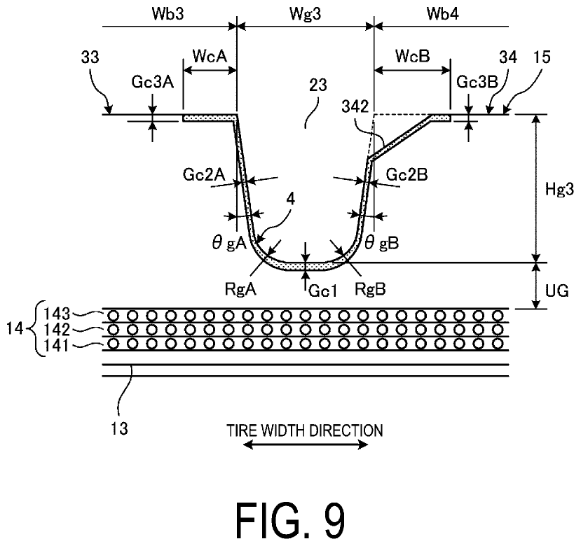

The width Wc of the stress relaxation layer 4 on the road contact surfaces of the land portions 31, 32 is measured as a distance in the tire width direction from the edge portions of the land portions 31, 32 to the edge portions of the stress relaxation layer 4 in a cross-sectional view in the tire meridian direction. In a configuration in which the edge portion of the land portion includes a chamfered portion (see FIG. 9 described below), the width Wc of the stress relaxation layer 4 is measured using an intersection point between the extension line of the groove wall of the main groove and the extension line of the road contact surface of the land portion as an end point.

In FIGS. 3 and 4, a total width ΣWc of the stress relaxation layer 4 on the road contact surface of one land portion 31, 32 with respect to the ground contact width Wb of the land portion 31, 32 (Wb1, Wb2) is in the range of ΣWc/Wb≤0.70 and preferably in the range of ΣWc/Wb≤0.68. Thus, the exposed width (dimension symbol omitted in the drawings) of the tread rubber on the road contact surface of the land portion 31, 32 with respect to the ground contact width Wb of the land portion 31, 32 is ensured to be 30% or more. The above-described upper limit ensures the exposed areas of the tread rubber 15 on the road contact surfaces of the land portions 31, 32 and thus ensures the wet performance of the tire at the early stage of wear. The lower limit of the ratio ΣWc/Wb is not particularly limited but is subject to restrictions by other conditions.

For example, in the configuration of FIG. 3, since the center main groove 22 does not include the stress relaxation layer 4, the total width ΣWc of the stress relaxation layer 4 on the road contact surface of the shoulder land portion 31 is WcA, and the total width ΣWc of the stress relaxation layer 4 on the road contact surface of the middle land portion 32 is WcB. On the other hand, in the configuration in which the stress relaxation layer 4 is formed at the center main grooves 22, 23 in addition to at the shoulder main grooves 21, 24 (see FIG. 2 and FIG. 8 described below), the width Wc of the stress relaxation layer 4 is present at each of the left and right edge portions of the middle land portion 32 on the left side in the drawing, the center land portion 33, and the middle land portion 34 on the right side in the drawing, and thus the total width Ewc of the stress relaxation layer 4 at each of the land portions 32 to 34 is set so as to satisfy the above-described condition.

In FIG. 4, the width Wc (WcA, WcB) of the stress relaxation layer 4 on the road contact surfaces of the land portions 31, 32 with respect to the ground contact width Wb of the land portion 31, 32 (Wb1, Wb2, see FIG. 2) is in the range of 0.02≤Wc/Wb≤0.50 and preferably in the range of 0.03≤Wc/Wb≤0.35. In a configuration in which the edge portions of the land portions 31, 32 have a straight shape, the ratio Wc/Wb is preferably set to be in the range of 0.02≤Wc/Wb≤0.12. The above-described lower limit appropriately ensures the width Wc of the stress relaxation layer 4 on the road contact surfaces of the land portions 31, 32, and the above-described upper limit ensures the exposed area of the tread rubber 15 on the road contact surfaces of the land portions 31, 32. For example, in the configuration of FIG. 3, since the edge portions of the land portions 31, 32 have a straight shape, the width Wc of the stress relaxation layer 4 is set to be narrower than that in the configuration of FIG. 8 described below. Since the shoulder land portion 31 and the middle land portion 32 include the stress relaxation layer 4 only at the edge portions on the shoulder main groove 21 side, the ratio ΣWc/Wb of the total width of the stress relaxation layer 4 is set to be small. Accordingly, the exposed area of the tread rubber 15 is ensured to be wide.

In FIG. 4, the width Wc (WcA, WcB) of the stress relaxation layer 4 on the road contact surfaces of the land portions 31, 32 with respect to a thickness Gd1 of the stress relaxation layer 4 at the groove bottom of the main groove 21 is in the range of 2.0≤Wc/Gc1≤70 and preferably in the range of 2.3≤Wc/Gc1≤65. The thickness Gd1 of the stress relaxation layer 4 at the groove bottom of the main groove 21 is in the range of 0.030 mm≤Gd1≤0.400 mm and preferably in the range of 0.040 mm≤Gd1≤0.380 mm. Accordingly, the thickness Gd1 of the stress relaxation layer 4 at the groove bottom of the main groove 21 is made proper, and the separation of the stress relaxation layer 4 during rolling of the tire is suppressed.

The thickness Gd1 of the stress relaxation layer 4 at the groove bottom of the main groove 21 is measured on the groove center line (not illustrated) of the main groove 21.

In FIG. 4, a minimum value Gc2_min of a thickness Gc2 (Gc2A, Gc2B) of the stress relaxation layer 4 in predetermined regions of the groove walls of the main groove 21 is smaller than the thickness Gd1 of the stress relaxation layer 4 in the groove bottom of the main groove 21 (Gc2_min<Gc1). In such a configuration, since the stress relaxation layer 4 includes thin portions on the groove walls of the main groove 21, the separation of the stress relaxation layer 4 at the groove bottom of the main groove 21 is suppressed. A ratio Gc2_min/Gc1 is in the range of Gc2_min/Gc1≤0.60, and preferably in the range of Gc2_min/Gc1≤0.40. The minimum value Gc2_min of the thickness Gc2 of the stress relaxation layer 4 is preferably 0.003 mm or more.

The thickness Gc2 (Gc2A, Gc2B) of the stress relaxation layer 4 at the respective groove walls of the main groove 21 is measured in a region of 40% or more and 60% or less of the groove depth Hg1 from the groove bottom of the main groove 21.

In FIG. 4, the minimum value Gc2_min of the thickness Gc2 (Gc2A, Gc2B) of the stress relaxation layer 4 on the groove walls of the main groove 21 is smaller than a thickness Gc3 of the stress relaxation layer 4 on the road contact surfaces of the land portions 31, 32 (Gc2_min<Gc3). In such a configuration, since the stress relaxation layer 4 includes the thin portions on the groove walls of the main groove 21, it is possible to suppress the separation of the entire stress relaxation layer 4 from the groove walls toward the groove bottom of the main groove 21 in a process in which portions of the stress relaxation layer 4 exposed on the road contact surfaces of the land portions 31, 32 are worn out during the progress of wear. A ratio Gc2_min/Gc3 is in the range of Gc2_min/Gc3≤0.60, and preferably in the range of Gc2_min/Gc3≤0.40.

In FIG. 4, the thickness Gc3 (Gc3A, Gc3B) of the stress relaxation layer 4 on the road contact surfaces of the land portions 31, 32 is in the range of 0.030 mm≤Gc3≤0.400 mm, and preferably in the range of 0.040 mm≤Gc3≤0.380 mm. Accordingly, deterioration in the performance of the tread contact surface due to the contact of the stress relaxation layer 4 with the ground is suppressed.

The thickness Gc3 of the stress relaxation layer 4 on the road contact surfaces of the land portions 31, 32 is measured as the maximum value of the thicknesses of the portions of the stress relaxation layer 4 exposed on the road contact surfaces of the land portions 31, 32.

In FIG. 4, left and right groove wall angles θgA, θgB degrees of the main groove 21 with respect to a groove width Wg (Wg1) mm and the groove depth Hg (Hg1) mm of the main groove 21 have the relationship 2.0×(Wg+Hg)−35.0≤θgA+θgB≤4.5×(Wg+Hg)−22.5 and preferably have the relationship 2.5×(Wg+Hg)−40.0≤θgA+θgB≤4.0×(Wg+Hg)−25.0. Accordingly, the adhesiveness of the stress relaxation layer 4 at the groove bottom of the main groove 21 is improved, and the separation of the stress relaxation layer 4 is effectively suppressed.

The groove wall angles θgA, θgB of the main groove 21 are each measured as an angle between the groove wall surface and a groove depth direction of the main groove 21 in a cross-sectional view in the tire meridian direction when the tire is mounted on the specified rim, inflated to the specified internal pressure, and in an unloaded state.

In FIG. 4, a curvature radius Rg_min that is smaller one of curvature radii RgA, RgB mm of the connection portions between the groove bottom and the left and right groove walls of the main groove 21 with respect to the groove width Wg (Wg1) mm, the groove depth Hg (Hg1) mm, and the left and right groove wall angles θgA, θgB degrees of the main groove 21 satisfies the condition of the mathematical formula (1) below. Accordingly, the distribution of the thickness of the stress relaxation layer 4 at the groove bottom of the main groove 21 is made proper, and the separation of the stress relaxation layer 4 is effectively suppressed.

$$0.16 \leq \frac{Rg\_min}{Wg - Hg \times tan θ gA - Hg \times tan θ gB} \leq 0.5 \qquad ( 1 )$$

The curvature radii RgA, RgB of the connection portions between the groove bottom and the left and right groove walls of the main groove 21 are measured in a cross-sectional view in the tire meridian direction when the tire is mounted on the specified rim, inflated to the specified internal pressure, and in an unloaded state.

In FIG. 4, the thickness Gc mm of the stress relaxation layer 4 in the groove bottom of the main groove 21 with respect to a groove bottom gauge UG mm of the tread rubber 15 is in the range of 0.055×e\hat{ }(−0.452×UG)≤Gc≤0.070×e\hat{ }(−0.620×UG)+0.150 and preferably in the range of 0.065×e\hat{ }(−0.368×UG)≤Gc≤0.070×e\hat{ }(−0.551×UG)+0.125.

The groove bottom gauge UG of the tread rubber 15 is measured as a rubber gauge from the groove bottom of the main groove 21 to the outermost layer (the belt cover 143 in FIG. 4) of the belt layer 14. Specifically, an imaginary line (not illustrated) connecting end points on the outer side in the radial direction of the belt cords constituting the outermost layer 143 of the belt layer 14 is drawn, and a distance from the groove bottom of the main groove 21 to the imaginary line is measured.

As illustrated in FIG. 5, the stress relaxation layer 4 extends along the main groove 21 in the tire circumferential direction and has the thickness Gc which is uniform. The stress relaxation layer 4 is disposed to cover the entire surface of a wear indicator 5. Thus, when the main groove 21 has a protrusion portion or a recess portion at the groove bottom, the stress relaxation layer 4 is preferably disposed so as to cover the entirety of the protrusion portion or the recess portion.

The protrusion portion or the recess portion formed at the groove bottom is preferably formed of a straight line and/or a curved line having a curvature radius of 10 mm or more in a cross-sectional view in the tire circumferential direction. Accordingly, the deformation of the protrusion portion or the recess portion during rolling of the tire is suppressed, and the separation of the stress relaxation layer 4 is suppressed. In the configuration of FIG. 5, each of a curvature radius Ri1 of the connection portion between a sidewall of the wear indicator 5 and the groove bottom of the main groove 21 and a curvature radius Ri2 of the connection portion between the sidewall and the top portion of the wear indicator 5 is set to 10 mm or more. When the height of the protrusion portion from the groove bottom is equal to or greater than one third of the groove depth Hg1 of the main groove 21 as in a snow platform (not illustrated), at least the curvature radius Ri1 of the connection portion between the sidewall of the protrusion portion and the groove bottom of the main groove 21 may satisfy the above condition.

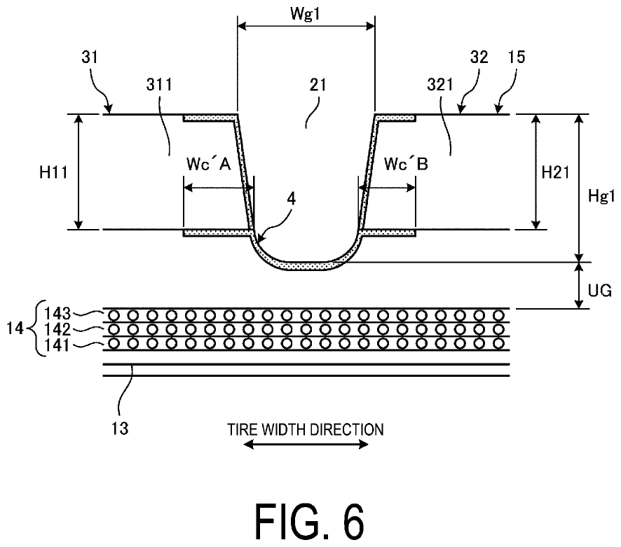

FIG. 6 is a cross-sectional view illustrating the shoulder main groove 21 illustrated in FIG. 3. The same drawing illustrates a cross-sectional view of the shoulder main groove 21 at the opening positions of the lug grooves 311, 321.

As illustrated in FIG. 6, at the intersection positions between the main groove 21 and the lug grooves 311, 321, the stress relaxation layer 4 extends continuously from the groove bottom of the main groove 21 to the groove bottoms of the lug grooves 311, 321 and terminates at the groove bottoms of the lug grooves 311, 321. A width Wc′ (Wc′A, Wc′B) of the stress relaxation layer 4 at the groove bottoms of the lug grooves 311, 321 with respect to the groove depth Hg (Hg1) of the main groove 21 is in the range of 0.06≤Wc′/Hg≤1.00 and preferably in the range of 0.10≤Wc′/Hg≤0.90. Since the stress relaxation layer 4 extends continuously from the groove bottom of the main groove 21 to the groove bottoms of the lug grooves 311, 321 as described above, the separation of the stress relaxation layer 4 at the groove bottom of the main groove 21 is effectively suppressed. For example, in the configuration of FIG. 6, groove depths H11, H21 of the lug grooves 311, 321 are shallower than the groove depth Hg1 of the main groove 21. Thus, steps are formed between the groove bottom of the main groove 21 and the groove bottoms of the lug grooves 311, 321. The stress relaxation layer 4 is formed so as to cover the edge portions of these steps. Accordingly, the separation of the stress relaxation layer 4 is effectively suppressed.

The width Wc′ (Wc′A, Wc′B) of the stress relaxation layer 4 at the groove bottoms of the lug grooves 311, 321 is defined as an extension distance in the tire width direction at the groove bottoms of the lug grooves 311, 321.

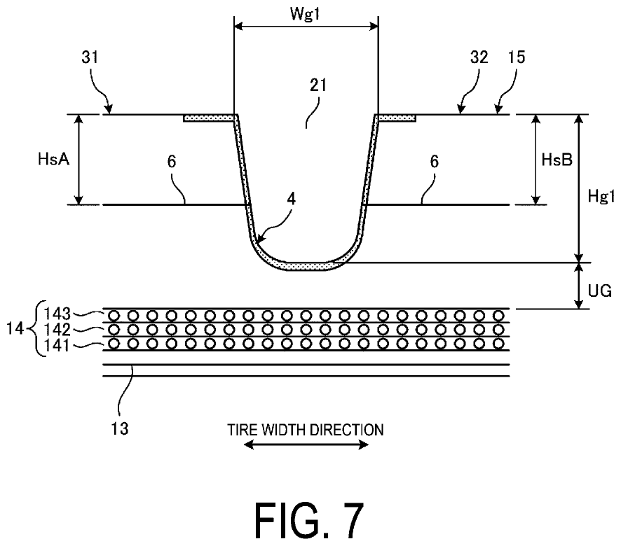

FIG. 7 is a cross-sectional view illustrating the shoulder main groove 21 illustrated in FIG. 3. The same drawing illustrates a cross-sectional view of the shoulder main groove 21 at the opening positions of the sipes 6.

In the configuration of FIG. 3, the land portions 31, 32 include a plurality of sipes 6, and some of the sipes 6 open to the main groove 21. In such a configuration, since a part of the stress relaxation layer 4 is divided in the tire circumferential direction by the opening portions of the sipes 6, the stress applied to the stress relaxation layer 4 during rolling of the tire is dispersed, and the separation of the stress relaxation layer 4 is suppressed. In FIG. 7, an opening depth Hs (HsA, HsB) of the sipes 6 with respect to the groove depth Hg (Hg1) of the main groove 21 is preferably in the range of 0.10≤Hs/Hg≤0.80. The above-described lower limit ensures the effect of suppressing the separation of the stress relaxation layer 4 by the sipes 6, and the above-described upper limit suppresses the occurrence of groove cracking starting from the sipes 6. An interval Ds between the sipes 6, 6 (not illustrated, see FIG. 3) adjacent to each other in the tire circumferential direction with respect to the groove depth Hg of the main groove 21 preferably has a relationship of Ds≤Hg.

The sipe 6 is a cut formed in the tread contact surface and has the maximum width of less than 1.5 mm and the maximum depth of 1.5 mm or more (dimension symbol omitted in the drawings), so that the sipe closes when the tire comes into contact with the ground. When the tire comes into contact with the ground, the sipe 6 absorbs and removes a water film on icy road surfaces, thereby improving adhesive properties (so-called adhesive friction force) of the road contact surface of the block 6 to the icy road surfaces. As a result, the performance on ice of the tire is improved.

The sipe width is measured as an opening width of the sipe in the tread contact surface when the tire is mounted on the specified rim, inflated to the specified internal pressure, and in an unloaded state.

The sipe depth is measured as a distance from the tread contact surface to a sipe bottom when the tire is mounted on the specified rim, inflated to the specified internal pressure, and in an unloaded state. In a configuration in which the sipe partially includes a raised bottom portion or a recess/protrusion portion at the sipe bottom, the sipe depth is measured excluding the portions.

The opening depth Hs (HsA, HsB) of the respective sipes 6 is measured as an extension length of the opening portion of the respective sipes 6 in the groove walls of the main groove 21 in the groove depth direction.

### MODIFIED EXAMPLES

FIG. 8 is an explanatory diagram illustrating a modified example of the tire 1 illustrated in FIG. 2. The same drawing illustrates an enlarged view of the center region of the tread surface. FIG. 9 is a cross-sectional view illustrating the center main groove 23 illustrated in FIG. 8. In these drawings, the constituents that are the same as the constituents illustrated in FIGS. 3 and 4 are denoted by the same reference signs, and the description thereof is omitted.

In the configuration of FIG. 2, as described above, the stress relaxation layer 4 is formed in each of the left and right shoulder main grooves 21, 24 but is not formed in the center main grooves 22, 23. However, no such limitation is intended, the stress relaxation layer 4 may be formed in the center main grooves 22, 23 in addition to the shoulder main grooves 21, 24 as illustrated in FIG. 8.

In the configuration of FIG. 8, the stress relaxation layer 4 is formed in each of the left and right center main grooves 22, 23. The center main groove 22 on the left side in the drawing has a zigzag shape having an amplitude in the tire width direction, and the stress relaxation layer 4 is disposed to cover the entire center main groove 22. The width Wc (WcA_min, WcA_max, WcB_min, WcB_max) of the stress relaxation layer 4 on the road contact surfaces of the land portions 32, 33 with respect to the groove depth Hg (not illustrated) of the center main groove 22 is in the range of 0.06≤Wc/Hg≤1.00. The width Wc (WcA_min, WcA_max, WcB_min, WcB_max) of the stress relaxation layer 4 on the road contact surfaces of the land portions 32, 33 with respect to the ground contact width Wb (Wb2, Wb3, see FIG. 2) of the land portions 32, 33 is in the range of 0.02≤Wc/Wb≤0.50.

In a configuration in which the stress relaxation layer 4 is formed in three or more main grooves (for example, four main grooves 21 to 24 in the modified example of FIG. 8), a total width ΣWc of the stress relaxation layer 4 on the tire ground contact surface with respect to the tire ground contact width TW is in the range of ΣWc/TW≤0.20 and preferably in the range of ΣWc/TW≤0.18. Accordingly, the exposed area of the tread rubber 15 on the tire ground contact surface is ensured, and the wet performance of the tire is ensured.

In the configuration of FIG. 8, the middle land portion 34 on the right side in the drawing includes a plurality of chamfered portions 342 at the edge portion on the center main groove 23 side. As illustrated in FIG. 9, the stress relaxation layer 4 is disposed so as to extend from the groove bottom of the center main groove 23 to the road contact surface of the middle land portion 34 and cover the chamfered portions 342 of the middle land portion 34. As described above, even in the configuration in which the land portion 34 includes the chamfered portions 342, the stress relaxation layer 4 extends to the road contact surface of the land portion 34 and is exposed, and thus the separation of the stress relaxation layer 4 is appropriately suppressed.

In the configuration of FIG. 2, the left and right shoulder main grooves 21, 24 have a straight shape, and thus the edge portions of the left and right land portions 31, 32 have a straight shape. On the other hand, the center main groove 22 on the left side in the drawing has a zigzag shape, and thus the edge portions of the land portions 32, 33 defined by the center main groove 22 have a zigzag shape. As illustrated in FIG. 8, the middle land portion 34 defined by the center main groove 23 on the right side in the drawing has the plurality of chamfered portions 342 at the edge portion on the center main groove 23 side, and thus the edge portion of the middle land portion 34 has a zigzag shape.

On the other hand, as illustrated in FIGS. 3 and 8, the stress relaxation layer 4 is formed in straight-shaped regions surrounding the main grooves 21 to 24 and the edge portions of the land portions 31 to 35 regardless of the shapes of the edge portions of the land portions 31 to 35 on the main grooves 21 to 24 side.

As in FIGS. 3 and 8 described above, in the configuration in which the stress relaxation layer 4 is formed in the straight-shaped regions, the process of forming the stress relaxation layer 4 can be made easier. Specifically, in the above-described configuration, the coating material of the stress relaxation layer 4 is applied to a predetermined position of the unvulcanized tread rubber 15, that is, regions surrounding the formation positions of the main grooves 21 to 24, and then the vulcanization molding process is performed to form the main grooves 21 to 24. Thus, compared to the process of applying the coating material of the stress relaxation layer to the tread rubber after vulcanization molding, the application process of the coating material is made easier.

However, no such limitation is intended, and the coating material of the stress relaxation layer may be applied to the tread rubber after vulcanization molding. In that case, in FIG. 8 for example, the stress relaxation layer 4 may be formed in a zigzag-shaped region along the zigzag shape of the center main groove 22 (not illustrated).

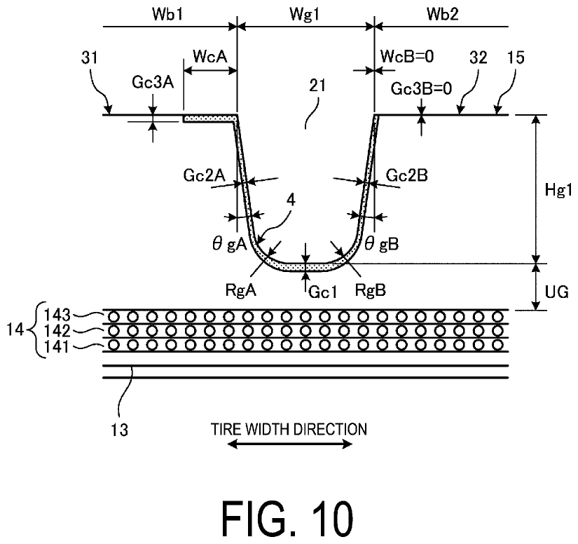

FIG. 10 is an explanatory diagram illustrating a modified example of the stress relaxation layer 4 illustrated in FIG. 4. In the same drawing, the constituents that are the same as the constituents illustrated in FIG. 4 are denoted by the same reference signs, and the description thereof is omitted.

In the configuration of FIG. 4, the stress relaxation layer 4 extends from the groove bottom of the main groove 21 to the road contact surfaces of the left and right land portions 31, 32 to cover the edge portions of the left and right land portions 31, 32. Thus, the left and right edge portions of the stress relaxation layer 4 are located at the road contact surfaces of the left and right land portions 31, 32, respectively. Such a configuration is preferable in that the separation of the stress relaxation layer 4 can be effectively suppressed.

On the other hand, in the configuration of FIG. 10, one edge portion of the stress relaxation layer 4 extends from the groove bottom of the main groove 21 to the road contact surface of the shoulder land portion 31, and the other edge portion terminates at the groove wall of the main groove 21 without exceeding the edge portion of the middle land portion 32. In this case, the width WcB of the stress relaxation layer 4 on the middle land portion 32 side is 0. Even with such a configuration, the effect of suppressing the separation of the stress relaxation layer 4 can be achieved.

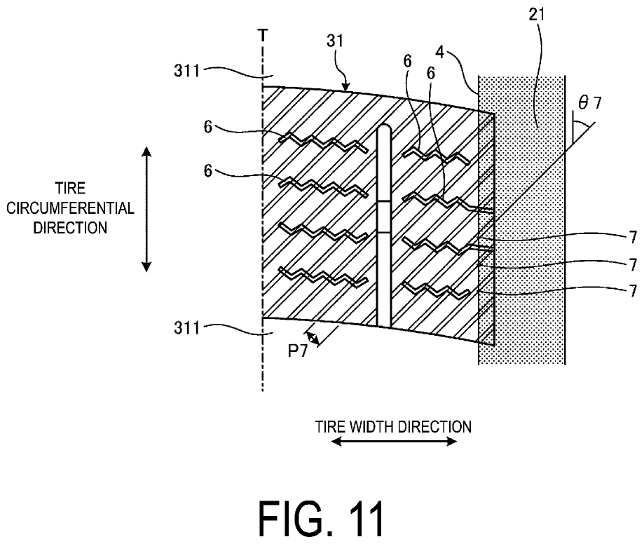

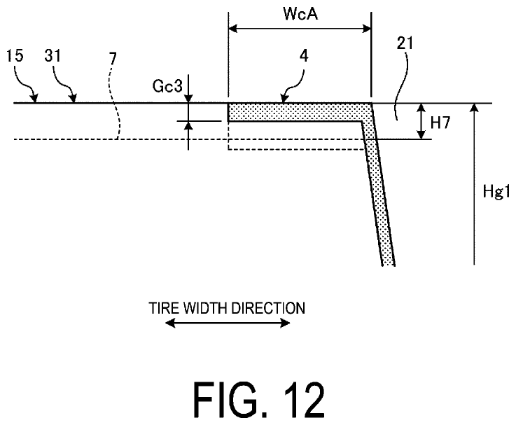

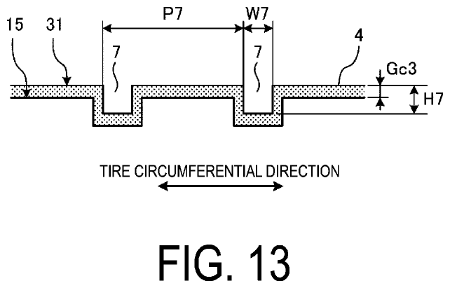

FIG. 11 is an explanatory diagram illustrating a modified example of the tire 1 illustrated in FIG. 2. The same drawing illustrates one block of the shoulder land portion 31. FIGS. 12 and 13 are explanatory diagrams illustrating a narrow shallow groove 7 of the shoulder land portion 31 illustrated in FIG. 11. In these drawings, FIG. 12 illustrates a cross-sectional view of the shoulder land portion 31 in the tire width direction, and FIG. 13 illustrates a cross-sectional view of the shoulder land portion 31 in the tire circumferential direction. In these drawings, the constituents that are the same as the constituents illustrated in FIGS. 2 to 4 are denoted by the same reference signs, and the description thereof is omitted.

In the configuration of FIG. 11, the land portion 31 (32 to 35) includes a plurality of narrow shallow grooves 7 in the ground contact surface. In such a configuration, since the narrow shallow grooves 7 absorb and remove a water film interposed between an icy road surface and the tread surface when the tire comes into contact with the ground, the braking performance on ice of the tire is improved.

The narrow shallow groove 7 has a groove width W7 of 0.1 mm or more and 0.6 mm or less and a groove depth H7 of 0.1 mm or more and 0.5 mm or less (see FIG. 13). Thus, the narrow shallow groove 7 is shallower than the sipe 6. The plurality of narrow shallow grooves 7 are disposed over the entire surfaces of the land portions 31 to 33. The plurality of narrow shallow grooves 7 are disposed over the entire region of the ground contact surface of the land portion 33. The plurality of narrow shallow grooves 7 are arranged side by side with a pitch length P7 (see FIG. 13) of 0.8 mm or more and 2.0 mm or less therebetween.

The groove width W7 of the narrow shallow groove 7 is measured as the maximum value of a distance between opposed groove walls of a groove opening portion in the tread contact surface when the tire is mounted on the specified rim, inflated to the specified internal pressure, and in an unloaded state.

The groove depth H7 of the narrow shallow groove 7 is measured as the maximum value of a distance from the tread contact surface to the groove bottom when the tire is mounted on the specified rim, inflated to the specified internal pressure, and in an unloaded state.

The pitch length P7 of the narrow shallow grooves 7 is defined as an arrangement interval between the narrow shallow grooves 7, 7 adjacent to each other.

For example, in the configuration of FIG. 11, the narrow shallow grooves 7 have a linear shape and have an inclination angle θ7 of 40 degrees or more and 90 degrees or less with respect to the tire circumferential direction. The narrow shallow grooves 7 extend through the land portion 31 to open to the main groove 21. However, no such limitation is intended, and the narrow shallow grooves 7 may have an arc shape or a wave-like shape (not illustrated). The narrow shallow grooves 7 may have a closed structure that does not extend through the land portion 31 (not illustrated).

As illustrated in FIGS. 12 and 13, the stress relaxation layer 4 extends to the road contact surface of the land portion 31 including the narrow shallow grooves 7 and covers the edge portion of the land portion 31. The stress relaxation layer 4 is formed to enter the grooves of the narrow shallow grooves 7. Specifically, the coating material of the stress relaxation layer 4 is applied to a predetermined position of the unvulcanized tread rubber 15, that is, the formation position of the main groove 21, and then the vulcanization molding process is performed to form the main groove 21 and the narrow shallow grooves 7. In such a configuration, the contact area between the stress relaxation layer 4 and the tread rubber 15 is increased by the narrow shallow grooves 7, and the adhesiveness of the stress relaxation layer 4 to the tread rubber 15 is improved. Accordingly, the separation of the stress relaxation layer 4 is effectively suppressed.

In FIGS. 12 and 13, a thickness Gc3 of the stress relaxation layer 4 on the road contact surface of the land portion 31 with respect to the groove depth H7 of the narrow shallow groove 7 is preferably in the range of 0.20≤Gc3/H7≤2.00. Accordingly, the adhesiveness of the stress relaxation layer 4 to the tread rubber 15 is ensured.

The color of the stress relaxation layer 4 is preferably the same as or similar to the color of the tread rubber 15. Specifically, the difference in brightness between them is 0.4 or less. This improves the appearance of the tire.

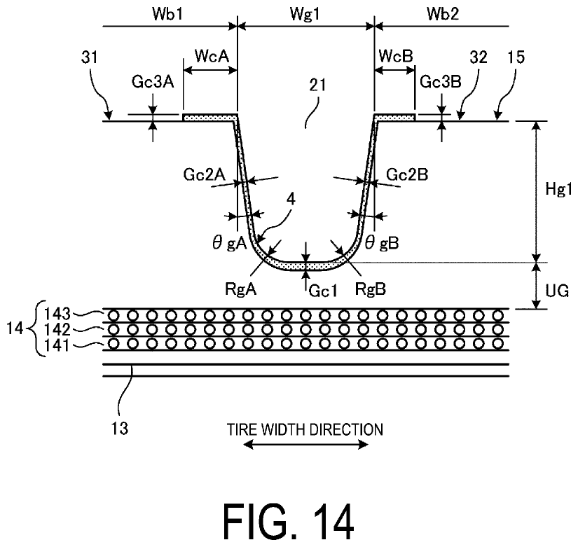

FIG. 14 is an explanatory diagram illustrating a modified example of the stress relaxation layer 4 illustrated in FIG. 4. In the same drawing, the constituents that are the same as the constituents illustrated in FIG. 4 are denoted by the same reference signs, and the description thereof is omitted.

In the configuration of FIG. 4, the outer surface of the stress relaxation layer 4 on the road contact surfaces of the land portions 31, 32 is flush with the exposed surface of the tread rubber 15. Thus, the exposed surface of the tread rubber 15 and the outer surface of the stress relaxation layer 4 are smoothly connected to each other without a step at the road contact surfaces of the land portions 31, 32. Such a configuration is preferable in that the appearance of the tire is improved because the road contact surfaces of the land portions 31, 32 are flat. Since the ground contact pressure of the road contact surfaces of the land portions 31, 32 is made uniform from the new condition of the tire to the early stage of wear, the tire rolling resistance is reduced, and the road contact surfaces of the land portions 31, 32 are maintained smooth even after the stress relaxation layer 4 is worn out. The above-described configuration is achieved in such a way that the coating material of the stress relaxation layer 4 is applied to predetermined positions of the unvulcanized tread rubber 15, that is, regions surrounding the formation positions of the main grooves 21 to 24, and then the vulcanization molding process is performed to form the main grooves 21 to 24 as described above. Specifically, by making an existing tire mold have a flat shape on the road contact surfaces of the land portions 31, 32, the stress relaxation layer 4 and the exposed surfaces of the tread rubber 15 are formed to be flush with each other.

On the other hand, in the configuration of FIG. 14, the outer surface of the tread rubber 15, that is, the exposed surface of the tread rubber 15 and the contact surface of the tread rubber 15 in contact with the stress relaxation layer 4 are flat at the road contact surfaces of the land portions 31, 32, and the stress relaxation layer 4 is layered on these flat surfaces of the tread rubber 15. Thus, the stress relaxation layer 4 protrudes from the exposed surface of the tread rubber 15 at the edge portions of the land portions 31, 32. The above-described configuration is formed, for example, by applying the coating material of the stress relaxation layer 4 to the tread rubber after vulcanization molding. Accordingly, as compared with the configuration of FIG. 4, the degree of freedom in forming the stress relaxation layer 4 is high, and thus the stress relaxation layer 4 described above can be formed in tires having various groove shapes.

The embodiments of FIGS. 4 and 14 are appropriately selected in consideration of the balance of a plurality of tire performances such as groove cracking resistance, wet performance, and low rolling resistance and the combination of the physical properties of the tread rubber 15 and the tread pattern of the tire.

### Effect

As described above, the tire 1 includes the tread rubber 15 exposed on the tread surface, the main grooves 21 to 24 and the land portions 31 to 35 formed on the tread surface, and the stress relaxation layers 4 formed on the surfaces of the groove bottoms of the main grooves (the left and right shoulder main grooves 21, 24 in FIG. 2) (see FIG. 2). The stress relaxation layer 4 is composed mainly of a diene rubber material and a non-diene rubber material and contains carbon, a vulcanizing agent, and a vulcanization accelerator. The stress relaxation layer 4 extends continuously from the groove bottom of the main groove 21 to the road contact surface of at least one of the land portions (the left and right land portions 31, 32 in FIG. 4) to cover the edge portions of the land portions 31, 32 in a cross-sectional view in the tire meridian direction (see FIG. 4). The width Wc of the stress relaxation layer 4 on the road contact surfaces of the land portions 31, 32 with respect to the groove depth Hg (Hg1) of the main groove 21 is in the range of 0.06≤Wc/Hg. The total width ΣWc of the stress relaxation layer 4 on the road contact surface of one of the land portions 31, 32 (ΣWc=WcA in the shoulder land portion 31 and ΣWc=WcB in the middle land portion 32 in FIG. 3) with respect to the ground contact width Wb (Wb1, Wb2) of the land portion 31, 32 is in the range of ΣWc/Wb≤0.70.

In such a configuration, since the stress relaxation layer 4 extends continuously from the groove bottom of the main groove 21 to the road contact surfaces of the land portions 31, 32 to cover the edge portions of the land portions 31, 32, the adhesion area of the stress relaxation layer 4 to the tread rubber 15 is increased as compared with a configuration in which the stress relaxation layer 4 is formed only in the groove bottom and the groove walls (not illustrated). Accordingly, the separation of the stress relaxation layer 4 during rolling of the tire is suppressed. The above-described lower limit of the ratio Wc/Hg appropriately ensures the width Wc of the stress relaxation layer 4 on the road contact surfaces of the land portions 31, 32 and appropriately suppresses the separation of the stress relaxation layer 4. That is, since the amount of deformation of the main groove 21 during rolling of the tire increases as the depth of the main groove 21 increases, the lower limit of the width Wc of the stress relaxation layer 4 is properly set with respect to the groove depth Hg of the main groove 21. The above-described upper limit of the ratio ΣWc/Wb ensures the exposed areas of the tread rubber 15 on the road contact surfaces of the land portions 31, 32 and thus ensures the wet performance of the tire at the early stage of wear. These have an advantage that both the durability of the stress relaxation layer 4 and the wet performance of the tire can be provided in a compatible manner.

In the tire 1, the modulus Mc of the stress relaxation layer 4 at 100% elongation at 100° C. with respect to the modulus Mt of the tread rubber 15 at 100% elongation at 100° C. is in the range of 0.45≤Mc/Mt≤1.15. The above-described lower limit ensures the modulus Mc of the stress relaxation layer 4 and has an advantage that breakage of the stress relaxation layer 4 due to a foreign matter (for example, a pebble) entering the main groove during rolling of the tire is suppressed. The above-described upper limit has an advantage that uneven wear of the land portion due to excessive increase in the modulus Mc of the stress relaxation layer 4 is suppressed.

In the tire 1, the rubber hardness Hc of the stress relaxation layer 4 with respect to the rubber hardness Ht of the tread rubber 15 is in the range of 0≤Ht−Hc≤32. The above-described lower limit ensures the rubber hardness Hc of the stress relaxation layer 4 and has an advantage that breakage of the stress relaxation layer 4 due to a foreign matter (for example, a pebble) entering the main groove during rolling of the tire is suppressed. The above-described upper limit has an advantage that uneven wear of the land portion due to excessive increase in the rubber hardness Hc of the stress relaxation layer 4 is suppressed.

In the tire 1, the tensile strength TBc of the stress relaxation layer 4 with respect to the tensile strength TBt of the tread rubber 15 is in the range of 0.30≤TBc/TBt≤0.90. The above-described lower limit has an advantage that the tensile strength TBc of the stress relaxation layer 4 is ensured, and the breaking durability of the stress relaxation layer 4 against a strain during rolling of the tire is ensured. The above-described upper limit has an advantage that the separation of the stress relaxation layer due to excessive increase in the tensile strength TBc of the stress relaxation layer 4 is suppressed.

In the tire 1, the width Wc (WcA, WcB) of the stress relaxation layer 4 on the road contact surfaces of the land portions 31, 32 with respect to the ground contact width Wb of the land portions 31, 32 (Wb1, Wb2) is in the range of 0.02≤Wc/Wb≤0.50 (see FIGS. 3 and 4). The above-described lower limit has an advantage that the width Wc of the stress relaxation layer 4 on the road contact surfaces of the land portions 31, 32 is appropriately ensured, and the above-described upper limit has an advantage that the exposed areas of the tread rubber 15 on the road contact surfaces of the land portions 31, 32 are ensured.

In the tire 1, the width Wc (WcA, WcB) of the stress relaxation layer 4 on the road contact surfaces of the land portions 31, 32 with respect to the thickness Gc1 of the stress relaxation layer 4 at the groove bottom of the main groove 21 is in the range of 2.0≤Wc/Gc1≤70 (see FIG. 4). The above-described lower limit has an advantage that the width Wc of the stress relaxation layer 4 on the road contact surfaces of the land portions 31, 32 is appropriately ensured, and the above-described upper limit has an advantage that the exposed areas of the tread rubber 15 on the road contact surfaces of the land portions 31, 32 are ensured.

In the tire 1, the thickness Gc1 (see FIG. 4) of the stress relaxation layer 4 at the groove bottom of the main groove 21 is in the range of 0.030 mm≤Gc1≤0.400 mm. This makes the thickness Gc1 of the stress relaxation layer 4 proper and has an advantage that the separation of the stress relaxation layer 4 during rolling of the tire is suppressed.

In the tire 1, the minimum value Gc2_min of the thickness Gc2 (Gc2A, Ge2B) of the stress relaxation layer 4 in the predetermined regions (defined as a region of 40% or more and 60% or less of the groove depth Hg1 from the groove bottom of the main groove 21) of the groove walls of the main groove 21 is smaller than the thickness Gc1 of the stress relaxation layer 4 at the groove bottom of the main groove 21 (see FIG. 4). In such a configuration, the stress relaxation layer 4 includes thin portions in the predetermined regions of the groove walls of the main groove 21, thus having an advantage that the separation of the stress relaxation layer 4 at the groove bottom of the main groove 21 is suppressed.

In the tire 1, the minimum value Gc2_min of the thickness Gc2 (Gc2A, Ge2B) of the stress relaxation layer 4 on the groove walls of the main groove 21 is smaller than the thickness Gc3 of the stress relaxation layer 4 on the road contact surfaces of the land portions 31, 32 (see FIG. 4). In such a configuration, the stress relaxation layer 4 includes thin portions on the groove walls of the main groove 21, thus having an advantage that the separation of the entire stress relaxation layer 4 from the groove walls toward the groove bottom of the main groove 21 is suppressed in a process in which portions of the stress relaxation layer 4 exposed on the road contact surfaces of the land portions 31, 32 are worn out during the progress of wear.

In the tire 1, the left and right groove wall angles θgA, θgB degrees of the main groove 21 with respect to the groove width Wg (Wg1) and the groove depth Hg of the main groove 21 have the relationship 2.0×(Wg+Hg)−35.0≤θgA+θgB≤4.5×(Wg+Hg)−22.5 (see FIG. 4). This improves the adhesiveness of the stress relaxation layer 4 at the groove bottom of the main groove 21 and has an advantage that the separation of the stress relaxation layer 4 is effectively suppressed.

In the tire 1, the curvature radius Rg_min that is smaller one of the curvature radii RgA, RgB mm of the connection portions between the groove bottom and the left and right groove walls of the main groove 21 with respect to the groove width Wg mm, the groove depth Hg mm, and the left and right groove wall angles θgA, θgB degrees of the main groove 21 satisfies the condition of the mathematical formula (1) below. This makes the distribution of the thickness of the stress relaxation layer 4 at the groove bottom of the main groove 21 proper and has an advantage that the separation of the stress relaxation layer 4 is effectively suppressed.

$$0.16 \leq \frac{Rg\_min}{Wg - Hg \times tan θ gA - Hg \times tan θ gB} \leq 0.5 \qquad ( 1 )$$

In the tire 1, the thickness Gc1 mm of the stress relaxation layer 4 at the groove bottom of the main groove 21 with respect to the groove bottom gauge UG mm of the tread rubber 15 is in the range of 0.055×e\hat{ }(−0.452×UG)≤Gc1≤0.070×e\hat{ }(−0.620×UG)+0.150 (see FIG. 4). The above-described lower limit suppresses the separation of the stress relaxation layer 4 during rolling of the tire, and the above-described upper limit ensures the durability of the stress relaxation layer 4.

### Target of Application

In the embodiments, a pneumatic tire has been described as an example of the tire. However, no such limitation is intended, and the configurations described in the embodiments can also be applied to other tires in a discretionary manner within the scope obvious to one skilled in the art. Examples of other tires include an airless tire and a solid tire.

### Examples

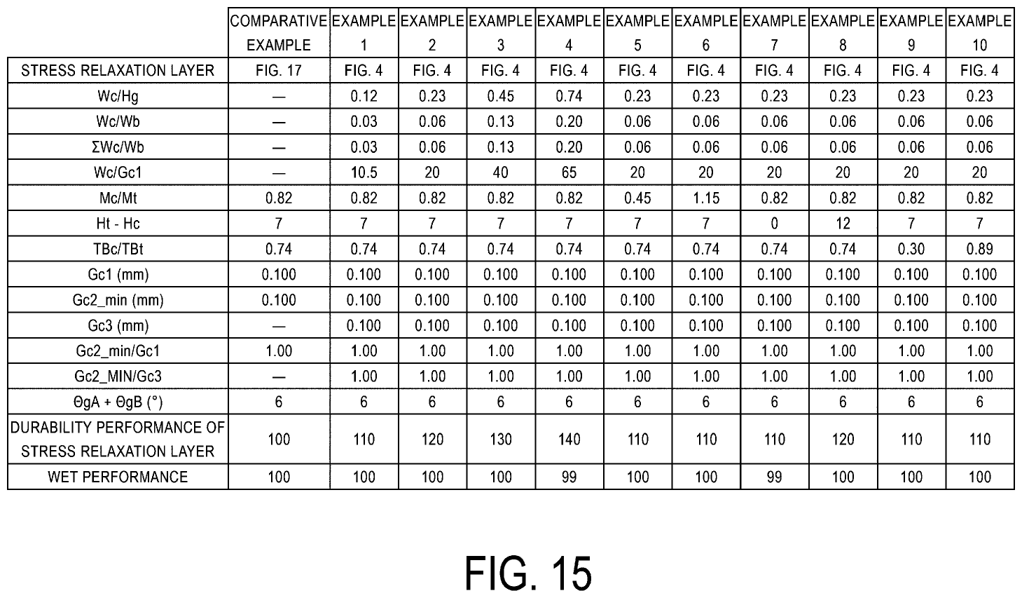

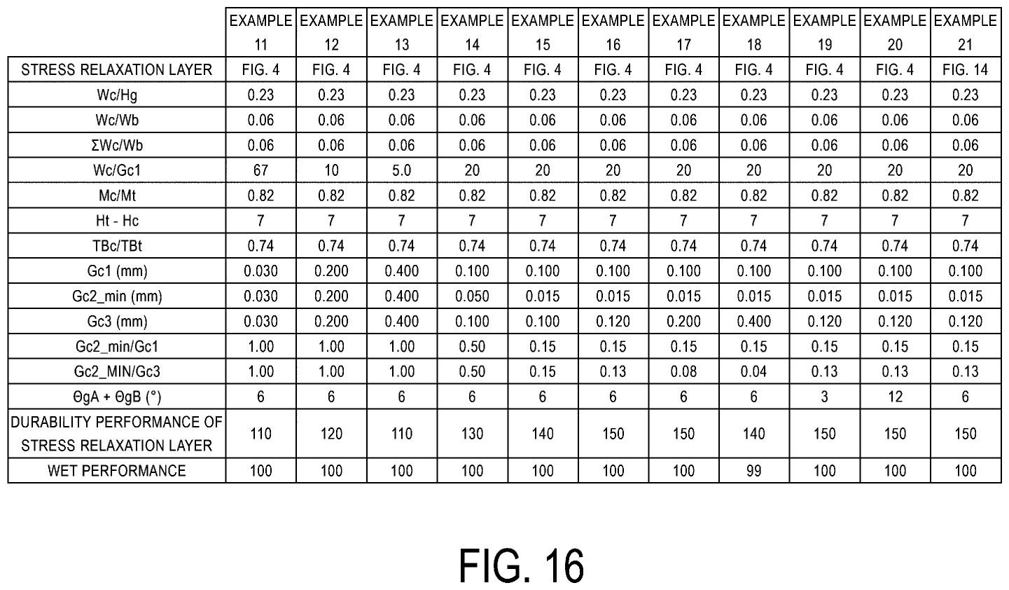

FIGS. 15 and 16 are tables showing the results of performance tests of the tires 1 according to the embodiments of the present technology. FIG. 17 is an explanatory diagram illustrating the test tire of Comparative Example.

In the performance tests, (1) durability performance of the stress relaxation layer and (2) wet performance of the tire were evaluated for a plurality of types of test tires. The test tires having a tire size of 225/65R17 were mounted on a rim having a rim size of 17×6.5J, and an internal pressure of 230 kPa and a specified load of 6.0 kN were applied to the test tires.
(1) An indoor drum testing machine having a drum diameter of 1707 mm was used in the evaluation of the durability performance of the stress relaxation layer to measure a distance traveled until the stress relaxation layer at the groove bottom portion was separated under a condition of a travel speed of 120 km/h. Then, the measurement results were expressed as index values and evaluated with Comparative Example being assigned as the reference (100). In this evaluation, larger values are preferable.
(2) In the evaluation of the wet performance, the test tires were mounted on all wheels of a front wheel drive vehicle having an engine displacement of 2000 cc. The test vehicle was driven on wet road surfaces with a water depth of 2 mm, and a braking distance from an initial speed of 80 km/h to a complete stop was measured. Then, the measurement results were expressed as index values and evaluated, with Comparative Example being assigned as the reference (100). In this evaluation, larger values indicate excellent braking performance on wet road surfaces and are preferable. When the evaluation is 98 or higher, the wet performance is considered to be properly ensured.

The test tires of Examples are assumed to have the configurations of FIGS. 1 to 5, and the left and right shoulder main grooves 21, 24 include the stress relaxation layer 4, and the left and right center main grooves 22, 23 do not include the stress relaxation layer 4. For the shoulder main groove 21 on the left side in the drawing, the groove width Wg1 is Wg1=7.0 mm, and the groove depth is Hg1=8.8 mm. The tire ground contact width TW is TW=180 mm, and the ground contact widths Wb1, Wb2 of the shoulder land portion 31 and the middle land portion 32 on the left side in the drawing are Wb1=32 mm and Wb2=44 mm. For the tread rubber 15, the modulus Mt of the cap tread at 100% elongation at 100° C. is 1.1 MPa, the rubber hardness Ht is 52, and the tensile strength TBt is 13.5 MPa.

The test tire of Comparative Example has the same configuration as the test tire of Example 1 except that the stress relaxation layer 4 terminates at the opening portions of the main grooves 21, 22, and the widths WcA, WcB of the stress relaxation layer 4 on the road contact surfaces of the land portions 31, 32 are 0 (see FIG. 16).

As can be seen from the test results, the test tires of Examples provide the durability performance of the stress relaxation layer and the wet performance of the tires in a compatible manner.

1. A tire, comprising:
a tread rubber exposed on a tread surface;
main grooves and land portions formed in the tread surface; and
a stress relaxation layer formed on a surface of a groove bottom of a main groove of the main grooves;
the stress relaxation layer being composed mainly of a diene rubber material and a non-diene rubber material and containing carbon, a vulcanizing agent, and a vulcanization accelerator,
the stress relaxation layer extending continuously from the groove bottom of the main groove to a road contact surface of at least one land portion of the land portions and covering an edge portion of the land portion in a cross-sectional view in a tire meridian direction,
a width Wc of the stress relaxation layer on the road contact surface of the land portion with respect to a groove depth Hg of the main groove being in a range of 0.06≤Wc/Hg, and
a total width ΣWc of the stress relaxation layer on the road contact surface of one of the land portions with respect to a ground contact width Wb of the land portions being in a range of ΣWc/Wb≤0.70.

2. The tire according to claim 1, wherein a modulus Mc of the stress relaxation layer at 100% elongation at 100° C. with respect to a modulus Mt of the tread rubber at 100% elongation at 100° C. is in a range of 0.45≤Mc/Mt≤1.15.

3. The tire according to claim 1, wherein a rubber hardness Hc of the stress relaxation layer with respect to a rubber hardness Ht of the tread rubber is in a range of 0≤Ht−Hc≤32.

4. The tire according to claim 1, wherein a tensile strength TBc of the stress relaxation layer with respect to a tensile strength TBt of the tread rubber is in a range of 0.30≤TBc/TBt≤0.90.

5. The tire according to claim 1, wherein the width Wc of the stress relaxation layer on the road contact surface of the land portions with respect to the ground contact width Wb of the land portions is in a range of 0.02≤Wc/Wb≤0.50.

6. The tire according to claim 1, wherein the width Wc of the stress relaxation layer on the road contact surface of the land portions with respect to a thickness Gd1 of the stress relaxation layer at the groove bottom of the main groove is in a range of 2.0≤Wc/Gc1≤70.

7. The tire according to claim 1, wherein a thickness Gd1 of the stress relaxation layer at the groove bottom of the main groove is in a range of 0.030 mm≤Gd1≤0.400 mm.

8. The tire according to claim 1, wherein a minimum value Gc2_min of a thickness Gc2 of the stress relaxation layer in a predetermined region of a groove wall of the main groove is smaller than a thickness Gd1 of the stress relaxation layer at the groove bottom of the main groove.

9. The tire according to claim 1, wherein a minimum value Gc2_min of a thickness Gc2 of the stress relaxation layer in a predetermined region of a groove wall of the main groove is smaller than a thickness Gc3 of the stress relaxation layer on the road contact surface of the land portions.

10. The tire according to claim 1, wherein left and right groove wall angles θgA, θgB degrees of the main groove with respect to a groove width Wg mm and the groove depth Hg mm of the main groove have a relationship 2.0×(Wg+Hg)−35.0≤θgA+θgB≤4.5×(Wg+Hg)−22.5.

11. The tire according to claim 1, wherein a minimum value Rg_min mm of curvature radii RgA, RgB of connection portions between the groove bottom and left and right groove walls of the main groove with respect to a groove width Wg mm, the groove depth Hg mm, and left and right groove wall angles θgA, θgB degrees of the main groove satisfies a following condition:
$$0.16 \leq \frac{Rg\_min}{Wg - Hg \times tan θ gA - Hg \times tan θ gB} \leq 0.5 \qquad ( 1 )$$

12. The tire according to claim 1, wherein a thickness Gd1 mm of the stress relaxation layer at the groove bottom of the main groove with respect to a groove bottom gauge UG mm of the tread rubber is in a range of 0.055×e\hat{ }(−0.452×UG)≤Gd1≤0.070×e\hat{ }(−0.620×UG)+0.150.
